(19) United States
(12) Patent Application Publication
(10) Pub. No.: US 2018/0137391 A1
(43) Pub. Date: May 17, 2018

(54) SYSTEM AND METHOD FOR TRAINING IMAGE CLASSIFIER

(71) Applicant: IMAGRY (ISRAEL) LTD., Haifa (IL)

(72) Inventors: Adham GHAZALI, Haifa (IL); Majed JUBEH, Jerusalem (IL); Sergey TEN, Haifa (IL)

(73) Assignee: IMAGRY (ISRAEL) LTD., Haifa (IL)

(21) Appl. No.: 15/810,171

(22) Filed: Nov. 13, 2017

Related U.S. Application Data
(60) Provisional application No. 62/421,288, filed on Nov. 13, 2016.

(51) Int. Cl. G06K 9/62; G06K 9/66; G06N 3/08; G06F 15/18; G06F 17/30

(52) U.S. Cl. CPC G06K 9/6267; G06K 9/66; G06K 9/6256; G06T 5/50; G06N 3/08; G06F 15/18; G06F 17/30244; G06K 9/6202

(57) ABSTRACT

Systems and methods of training an image classifier, including receiving, by a processor, at least two images, each of the at least two images being pre-classified to at least one category, randomly assigning a weight to each of the at least two images, calculating a weighted value for each pixel in each of the at least two images, creating, by the processor, a combined image based on a sum of the weighted values of each pixel, assigning the combined image the classification of the image assigned the highest weight, and transferring the combined image to the image classifier.

### CROSS REFERENCE TO RELATED APPLICATION

This application claims priority to and the benefit of Provisional Application No. 62/421,288, filed Nov. 13, 2016, the entire contents of which are incorporated herein by reference in its entirety.

### FIELD OF THE INVENTION

The present invention relates to image classification. More particularly, the present invention relates to systems and methods for using images to train a classifier.

### BACKGROUND OF THE INVENTION

Image identification is usually carried out with image processing of a given image, the image processing based on a collection of image databases. The image can be initially scanned for known patterns, for example taken from a pattern database (e.g., with patterns for cars, horses, etc.), and these patterns can then be compared to the image to identify the object in that image. With various improvements in computer technology in recent years, different applications can require image identification, however such identification usually requires large computing resources and/or large periods of time to process.

With incorporation of machine learning for image identification, one of the most common tasks is to fit a “model” to a set of training data, so as to be able to make reliable predictions on general untrained data (e.g., unclassified images). Thus, overfitting describing random errors or noise instead of the underlying relationship, can occur when a model is complex, for instance having too many parameters relative to the number of observations (such as in image identification). An overfit model usually has poor predictive performance, for example misclassifying cups with and without handles (for example only identifying cups without handles as cups), and therefore a reduction of overfitting is required.

Some commercially available training methods can be applied for datasets including images, where each data point (or image) in the dataset corresponds to an image “manifold” representation of a topological space resembling Euclidean space. Such a manifold is concentrated around an original image and thereby may miss (or misidentify) similar images in that space (for example only identifying cups without handles as cups). For example, with two-dimensional images, each image includes ‘N’×‘M’ pixels that can be regarded as a two-dimensional vector and such vectors can be distributed around a low-dimensional surface, embedded into ‘N’×‘M’ dimensional Euclidean space. Such vectors can be manipulated with data augmentation, for instance applied separately to each single augmented image using some random parameter.

### SUMMARY OF THE INVENTION

There is provided, in accordance with some embodiments of the invention, a method of training an image classifier, the method including receiving, by a processor, at least two images, each of the at least two images being classified, e.g., pre-classified, to at least one category, randomly assigning a weight to each of the at least two images, calculating a weighted value for each pixel in each of the at least two images, creating, by the processor, a combined image based on a sum of the weighted values of each pixel, assigning the combined image the classification of the image assigned the highest weight, and transferring or send the combined image to the image classifier.

In some embodiments, a transformation may be randomly selected from a list of transformation stored in a memory, for each image of the at least two images, and at least one image of the at least two images may be transformed according to the selected transformation. In some embodiments, an overall weighted value may be calculated for each image of the at least two images, and an image with the highest overall weighted value may be determined. In some embodiments, the size of at least one image of the at least two images may be adjusted until each of the at least two images have the same number of pixels. In some embodiments, the assigned classification may be displayed.

In some embodiments, the combined image may be added to a database of classified images. In some embodiments, combined image may be created using at least one of alpha-blending and optical flow methods. In some embodiments, the number of pixels in each image may be checked for correspondence to other images of the at least two images.

There is provided, in accordance with some embodiments of the invention, a system for image classifier training, including a memory module, configured to allow storage of images, an image database, comprising a set of classified images corresponding to a set of predefined classification categories, a processor, configured to create new images from at least two images of the image database based on the classification categories, and an image classifier, configured to classify images to at least one category. In some embodiments, the image creation may include calculation of sum of values for each pixel in the image.

In some embodiments, the system may include at least one neural network corresponding to a particular classification, wherein each neural network comprises at least one processor. In some embodiments, the memory module and the processor may be embedded into a computerized device, and wherein the computerized device may be selected from a group consisting of: mobile phone, tablet, and personal computer (PC).

In some embodiments, the processor may be configured to randomly select a transformation, from a list of transformation stored in the memory module, for each image of the at least two images, and transform at least one image of the at least two images according to the selected transformation. In some embodiments, the processor may be configured to calculate an overall weighted value for each image of the at least two images, and determine an image with the highest overall weighted value.

In some embodiments, the processor may be configured to adjust the size of at least one image of the at least two images until each of the at least two images have the same number of pixels. In some embodiments, the processor may be configured to add the combined image to a database of classified images. In some embodiments, the processor may be configured to check that the number of pixels in each image corresponds to other images of the at least two images. In some embodiments, the system may include a display coupled to the processor, and wherein the processor may be configured to display the assigned classification.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanying drawings in which:

FIG. 1 shows a block diagram of an exemplary computing device, according to an embodiment of the present invention;

FIG. 2 shows a block diagram of an image classifier training system, according to an embodiment of the present invention;

FIG. 3 show a flowchart of a method of training image classifiers, according to an embodiment of the present invention; and

FIG. 4 schematically illustrates an exemplary combination of images, according to an embodiment of the present invention.

It will be appreciated that for simplicity and clarity of illustration, elements shown in the figures have not necessarily been drawn to scale. For example, the dimensions of some of the elements can be exaggerated relative to other elements for clarity, or several physical components may be included in one functional block or element. Further, where considered appropriate, reference numerals can be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention can be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

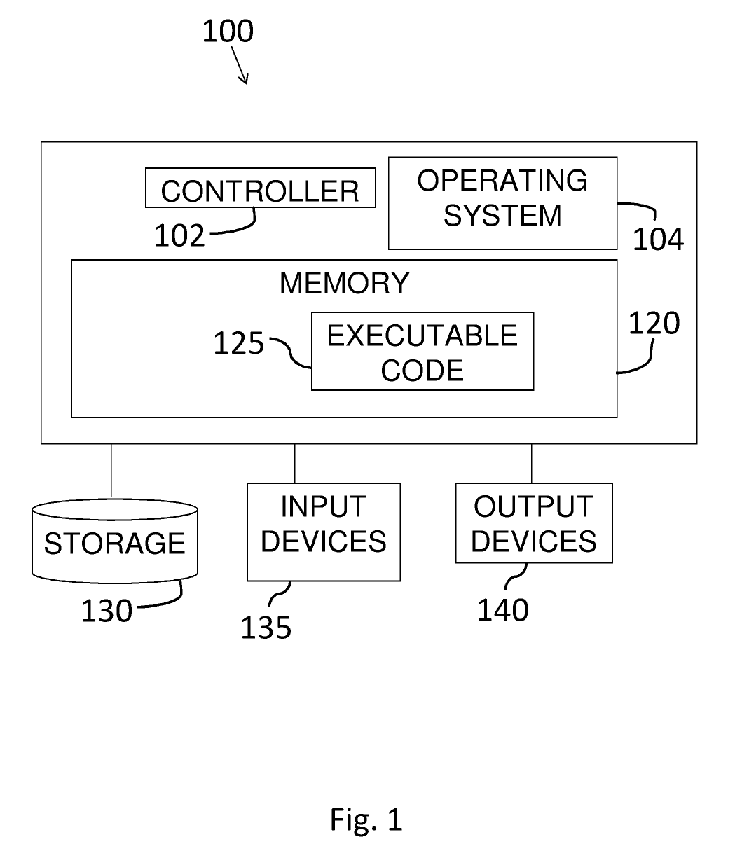

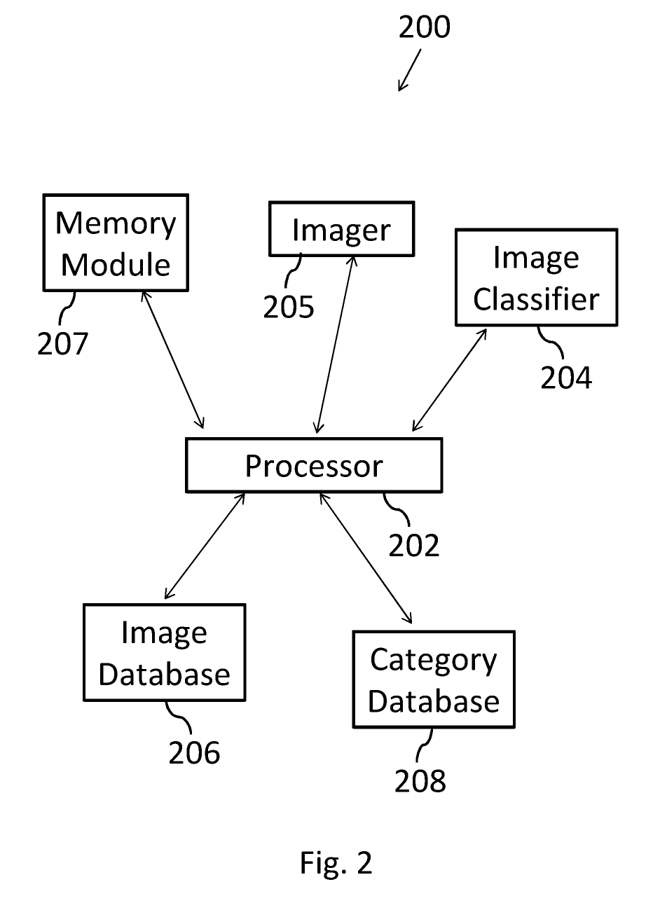

Reference is now made to FIG. 1, which shows a block diagram of an exemplary computing device 100, according to some embodiments of the invention. The computing device of FIG. 1, or components of the device of FIG. 1, may for example be used in various components of FIG. 2, e.g., an image database, a processor, an image classifier, etc. Computing device 100 may include a controller 102 that may be, for example, a central processing unit processor (CPU), a chip or any suitable computing or computational device, an operating system 104, a memory 120, a storage 130, at least one input device 135 and at least one output devices 140.

Operating system 104 may be or may include any code segment designed and/or configured to perform tasks involving coordination, scheduling, arbitration, supervising, controlling or otherwise managing operation of computing device 100, for example, scheduling execution of programs. Operating system 104 may be a commercial operating system. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 20 may be or may include a plurality of, possibly different memory units.

Executable code 125 may be any executable code, e.g., an application, a program, a process, task or script. Executable code 125 may be executed by controller 102 possibly under control of operating system 104. For example, executable code 125 may be an application for image classification. Where applicable, executable code 125 may carry out operations described herein in real-time. Computing device 100 and executable code 125 may be configured to update, process and/or act upon information at the same rate the information, or a relevant event, are received. In some embodiments, more than one computing device 100 may be used. For example, a plurality of computing devices that include components similar to those included in computing device 100 may be connected to a network and used as a system. For example, image classification may be performed in real-time by executable code 125 when executed on one or more computing devices such as computing device 100.

Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in storage 130 and may be loaded from storage 130 into memory 120 where it may be processed by controller 102. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a modem, printer or facsimile machine, a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 102.

The non-transitory storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

Reference is now made to FIG. 2, which shows a block diagram of an image classifier training system 200, according to some embodiments of the invention. It is noted that the direction of arrows may indicate the direction of information flow in FIG. 2. It should be appreciated that image classifier training system 200 may reduce overfitting of an image classifier 204 by training the image classifier 204 to classify images, and while reduction of overfitting is discussed hereinafter in regard to image classification the same may apply to other types of media (e.g., audio samples) with appropriate modifications. For example, multispectral images such as utilized for medical imaging (e.g., in MRI, X-ray, CT, etc.) may provide improved results after overfitting reduction. Other examples of media applicable for overfitting reduction may be ultra-sonic images as well as microwave images.

According to some embodiments, image classifier training system 200 may include a processor 202, configured to train image classifier 204 on images which may be assigned a category, class or classification. For example, images may be pre-classified or pre-assigned to categories or classifications with a dedicated classification algorithm. Classifications or categories may for example describe the content, subject, theme etc. of the image, such as animals, people, scenery, etc. In some embodiments, at least one pre-classified image may be received from an image database 206 where each image may be classified to at least one category. The training, for example as carried out by processor 202, may be based on the classification categories of a classification database 208 with the image classifier training system 200 trained to classify an unclassified image according to at least one predefined classification category. The set of predefined classification categories may be defined prior to performing image classification, for example, by providing a set of basic categories such as vehicles, animals, plants, etc. In some embodiments, the received image may be fed to a for example convolutional neural network (CNN) image classifier that is trained to predict the output (expected from preprocessing analysis).

In some embodiments, processor 202 (e.g., such as controller 102 in FIG. 1) may include a plurality of processors. According to some embodiments, image classifier training system 200 may include an imager 205, configured to allow capturing and/or receiving an unclassified image, for example capturing an unclassified image with a camera of a smartphone or receiving an unclassified image from a predefined database. In some embodiments, image classifier training system 200 may include a memory module 207 (e.g., corresponding to storage 130 or memory 120 in FIG. 1). Memory module 207 may be configured to allow storage of at least one of the received pre-classified images, for instance from image database 206, and/or unclassified images, for instance from imager 205, and/or predefined classification categories, for instance from category database 208.

In some embodiments, at least one of imager 205 and/or memory module 207 and/or processor 202 may be embedded into a computerized device, for instance embedded into a mobile phone, and/or a tablet computer and/or a personal computer (PC). It may be appreciated that various components such as processor 202, imager 205, category database 208 and memory module 207 may include components such as shown in FIG. 1, and may be configured to carry out embodiments of the invention by for example executing (or having a processor execute) code or software, and/or by including dedicated code.

According to some embodiments, training of image classifier 204 by image classifier training system 200 may be carried out for each category of category database 208, as further described hereinafter. Each such category may correspond to multiple pre-classified images (e.g., “N” two-dimensional or three-dimensional images of various sizes), for instance stored at image database 206.

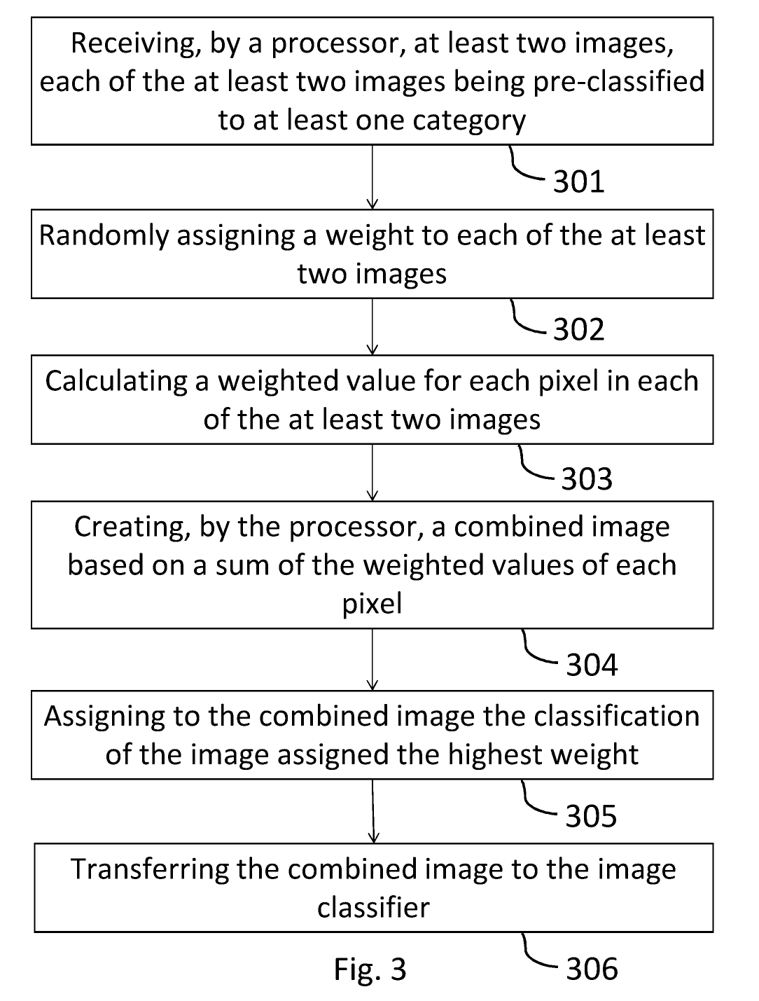

Reference is now made to FIG. 3, which shows a flowchart of a method of training image classifiers, according to some embodiments of the invention. While the computer systems shown in other figures may be used to carry out the operations of FIG. 3, other or different systems may be used. It should be noted that a method for training image classifiers with data augmentation for a collection of images (as further described hereinafter), rather than with a manifold centered on a single image, may overcome the deficiencies of the known manifold training methods and allow classification of samples that may also be outside of the manifold.

According to some embodiments, a method of training image classifiers may include receiving 301, by the processor 202, at least two images, where each of the at least two images may be pre-classified to at least one category (e.g., from category database 208). For instance an image of a cat and another image of a snake may be received, both classified to “animal” category (where some image identification methods can only identify cats).

Some embodiments may include assigning 302 a weight to each of the at least two images, for example randomly assigning a weight. In some embodiments, the sum of the weights assigned across images may be equal to one; other totals may be used.

It should be noted that each pixel in an image may have a numeric value (for instance 0-255 representing the brightness of the pixel, or another parameter or value), so the assignment 302 of a weight to an image results in the same weight applied to or assigned to each pixel in that image Some embodiments may include calculating 303 a combined sum of weighted values for sets of corresponding pixels across images, e.g., a combined sum of weighted values for each pixel (index ‘j’) in each of the at least two images (index ‘i’):

Gⱼ=ΣᵢⱼwᵢIᵢⱼ,Σᵢⱼwᵢ=1 (1)

where ‘Gⱼ’ is the combined sum (for each pixel ‘j’) of the weighted values of the images ‘i’, ‘wᵢ’ is the weight assigned to the image in which the pixel appears, and ‘Iᵢⱼ’ is the value of the pixel ‘j’ in the image ‘i’. For an image of size n×m, the index ‘j’ permutates between 1 and n×m such that pixel values of the same index, or of the same position, or of corresponding pixels, in different images may be summed Therefore, for each pixel ‘j’ a sum may be calculated 303 over the weighted values of pixel ‘j’ in the corresponding images.

It should be appreciated that the received 301 at least two images may be in different sizes and therefore may have different number of pixels. Some embodiments may include adjusting the size, by the processor 202, of at least one image (for instance using known methods for image resizing or image scaling) of the at least two images until all images have the same number of pixels. Then, for each pixel a weighted combined sum may be calculated 303 for the at least two images. In some embodiments, an image with the highest weight may determine the size to which the size of other images may be adjusted. In some embodiments, at least one image size may be predetermined, such that other images may be adjusted to the predetermined image size. In some embodiments, for two-dimensional images a limit on image sizes may be that an image with the highest assigned 302 weight is at least four percent of the number of pixels of an image with the highest number of pixels.

Some embodiments may include checking that the number of pixels in each image corresponds to other images of the at least two images. In case that the number of pixels do not match, the size of at least one image with lower number of pixels may be adjusted.

For example, when processing, by the processor 202, three images (e.g., from image database 206) the first random weight is w₁ (e.g., 0.3), the second random weight is w₂ (e.g., 0.2) and the third weight must in one example be (1−w₁−w₂) so for each pixel (‘j’) the combined weighted sum is:

Gⱼ=w₁I₁ⱼ+w₂I₂ⱼ+w₃I₃ⱼ=w₁I₁ⱼ+w₂I₂ⱼ+(1−w₁−w₂)I₃ⱼ (2)

Some embodiments may include creating 304, by the processor 202, a combined image based on a combined sum of the weighted values of each pixel. It should be appreciated that in such a combined image, an image assigned the highest weight may have greater contribution to the combined image since the combination is based on weighted sum for or applied to each pixel. In some embodiments, the combination of values for each pixel in the created image may be carried out using alpha-blending, e.g. according to equation (1), using optical flow, using other known methods of image processing or any combination thereof.

For instance after calculation 303 of the weighted values for each pixel, processor 202 may create a new unclassified image (e.g., stored in image database 206) where each pixel in the new unclassified image has a value corresponding to the sum of the weighted values of the original images. It should be noted that the newly created image may not belong to the image manifold of the original images, since a completely new image is created. The newly created image may be even incomprehensible to a human observer since such a weighted sum may create an image without clearly distinguishable objects, and therefore require a computerized device for such processing. It should be noted that for the newly created image, the structure of data may be identified rather them the texture (or object) of the image.

Some embodiments may include assigning 305 the (newly created) combined image the classification of the image assigned the highest weight. Some embodiments may include calculating an overall weighted value (or sum of all weighted values) for the pre-classified original images such that it may be possible to determine an image with highest weight. In some embodiments, the classification of the determined image with highest weight may be stored at memory module 207.

Some embodiments may include transferring or sending 306 the combined image to the image classifier 204 for training.

For example, three images may be combined where a first image shows a dog and assigned the random weight 0.2, the second image shows a cat and assigned the random weight 0.5, and the third image shows a car and assigned the random weight 0.3 such that the third image may be determined (e.g., by processor 202) to have highest weight. The new combined image may have combined values in each pixel and be assigned the classification of the third image with the highest weight.

It should be appreciated that the newly created image may be assigned a category and then be added to image database 206 as another image that is assigned a category from category database 208. Therefore, the number of samples (for each category) in image database 206 to be classified by image classifier 204 may increase, with addition of new images, and image classifier 204 may be trained to identify new images.

For example, a classifier that may classify images of cups with handles may be trained with newly created images that are also classified as “cups” after being assigned the highest weight, while these new images may possibly show incomprehensible images. Thus, image classifier 204 may be trained with these newly added images and identify more samples as cups even if the image does not have the cup's handle.

In some embodiments, the addition of the combined images may expand the image samples (for a particular category) according to:

TS=S^{N} (3)

where ‘S’ is the number of original training samples, and ‘N’ is the number of iteration of training of the classifier with the new images.

In some embodiments, image processing with feed-forward neural networks may implement such training of image classifiers as a memory layer, for example combining a current image with an image from previous processing.

Some embodiments may include randomly selecting, by processor 202, a transformation (e.g., rotation), from a list of transformations stored in a memory 207, for each image of the at least two images, and transforming at least one image of the at least two images according to the selected transformation.

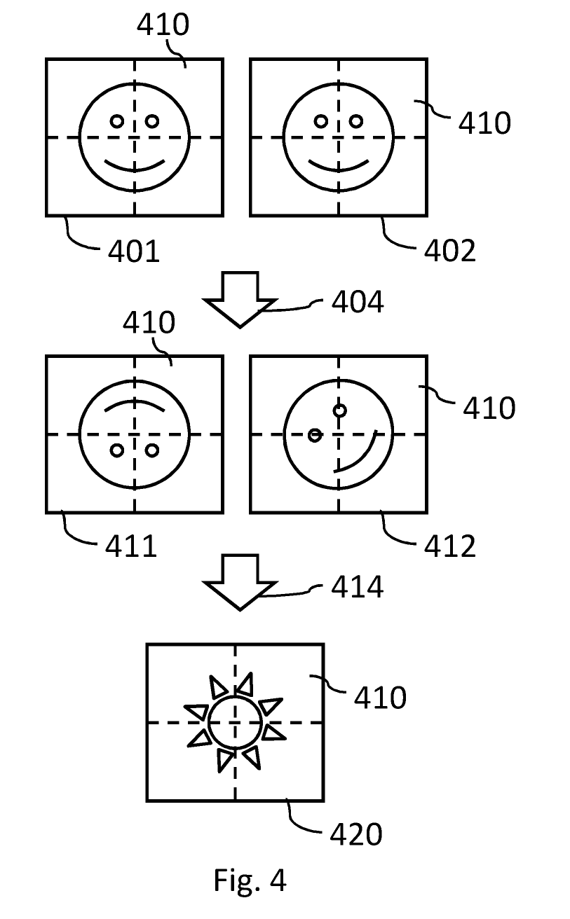

Reference is now made to FIG. 4, which schematically illustrates an exemplary combination of images, according to some embodiments of the invention. Two pre-classified images are received, a first image 401 and a second image 402 each assigned a random weight. Each image 401, 402 is transformed 404 (e.g., by rotation) and then become transformed first image 411 and transformed second image 412, for instance stored in memory module 207.

After transformation, the images 401, 402 may be combined 414 to create a newly combined image 420, where for each pixel 410 the combined image 420 has a sum of weighted values. It should be noted that the created new image may show something that cannot be identified as the same object by a human observer as the original images.

Some embodiments may include receiving an unclassified image to be classified by image classifier after the training, for example capturing an image with a camera of a smartphone or mobile device or receiving an image from a predefined database.

Some embodiments may include comparing, by processor 202, a new image to at least one classified image (e.g., from image database 206). Some embodiments may include assigning, by processor 202, a classification to the received unclassified image, based on the output of a categorization algorithm.

In some embodiments, classified images may be stored at a dedicated image database 206 such that it may be possible to compare a new image to classified images, for example using image processing.

Some embodiments may include displaying the assigned classification, for example displaying to the user “dog” on the mobile device.

Unless explicitly stated, the method embodiments described herein are not constrained to a particular order in time or chronological sequence. Additionally, some of the described method elements can be skipped, or they can be repeated, during a sequence of operations of a method.

Various embodiments have been presented. Each of these embodiments can of course include features from other embodiments presented, and embodiments not specifically described can include various features described herein.

1. A method of training an image classifier, the method comprising:
receiving, by a processor, at least two images, each of the at least two images being pre-classified to at least one category;
randomly assigning a weight to each of the at least two images;
calculating a weighted value for each pixel in each of the at least two images;
creating, by the processor, a combined image based on a sum of the weighted values of each pixel;
assigning to the combined image the classification of the image assigned the highest weight; and
transferring the combined image to the image classifier.

2. The method according to claim 1, further comprising:
randomly selecting, by the processor, a transformation, from a list of transformations stored in a memory, for each image of the at least two images; and
transforming, by the processor, at least one image of the at least two images according to the selected transformation.

3. The method according to claim 1, further comprising:
calculating an overall weighted value for each image of the at least two images; and
determining an image with the highest overall weighted value.

4. The method according to claim 1, further comprising adjusting the size of at least one image of the at least two images until each of the at least two images have the same number of pixels.

5. The method according to claim 1, further comprising displaying the assigned classification.

6. The method according to claim 1, further comprising adding the combined image to a database of classified images.

7. The method according to claim 1, wherein the combined image is created using at least one of alpha-blending and optical flow methods.

8. The method according to claim 1, further comprising checking that the number of pixels in each image corresponds to other images of the at least two images.

9. A system for image classifier training, the system comprising:
a memory module, configured to allow storage of images;
an image database, comprising a set of classified images corresponding to a set of predefined classification categories;
a processor, configured to create new images from at least two images of the image database based on the classification categories; and
an image classifier, configured to classify images to at least one category, wherein the image creation comprises calculation of sum of values for each pixel in the image.

10. The system of claim 9, further comprising at least one neural network corresponding to a particular classification, wherein each neural network comprises at least one processor.

11. The system of claim 9, wherein the memory module and the processor are embedded into a computerized device, and wherein the computerized device is selected from a group consisting of: mobile phone, tablet, and personal computer (PC).

12. The system of claim 9, wherein the processor is configured to randomly select a transformation, from a list of transformation stored in the memory module, for each image of the at least two images, and transform at least one image of the at least two images according to the selected transformation.

13. The system of claim 9, wherein the processor is configured to calculate an overall weighted value for each image of the at least two images, and determine an image with the highest overall weighted value.

14. The system of claim 9, wherein the processor is configured to adjust the size of at least one image of the at least two images until each of the at least two images have the same number of pixels.

15. The system of claim 9, further comprising a display coupled to the processor, and wherein the processor is configured to display the assigned classification.

16. The system of claim 9, wherein the processor is configured to add the combined image to a database of classified images.

17. The system of claim 9, wherein the processor is configured to check that the number of pixels in each image corresponds to other images of the at least two images.

18. A method of training an image classifier, the method comprising:
receiving, by a processor, at least two images, each of the at least two images is corresponding to a category, each of the at least two images having a weight;
creating, by the processor, a combined image, each pixel in the combined image created based on a weighted sum of the values of pixels in the at least two images;
assigning the combined image the classification of the image assigned the higher weight; and
sending the combined image to the image classifier.
